(19) United States
(12) Patent Application Publication
(10) Pub. No.: US 2021/0384621 A1
(43) Pub. Date: Dec. 9, 2021

(54) COMBINED ANTENNA AND RADOME ARRANGEMENT

(71) Applicant: Telefonaktiebolaget LM Ericsson (publ), Stockholm (SE)

(72) Inventors: Stefan JOHANSSON, Romelanda (SE); Livia CERULLO, Göteborg (SE); Lars PERSSON, Åsa (SE); Mikael POHLMAN, Göteborg (SE); Torbjöm WESTIN, Partille (SE)

(73) Assignee: Telefonaktiebolaget LM Ericsson (publ), Stockholm (SE)

(21) Appl. No.: 16/323,998

(22) PCT Filed: Jan. 18, 2019
(86) PCT No.: PCT/EP2019/051215

§ 371 Date: Feb. 7, 2019

(51) Int. Cl. H01Q 1/42; H01Q 1/24

(52) U.S. Cl. CPC H01Q 1/422; H01Q 1/246

(57) ABSTRACT

There is provided a combined antenna and radome arrangement. The combined antenna and radome arrangement comprises an advanced antenna system (AAS). The AAS comprises antenna elements and is configured for communication in a frequency range of 2.5 GHz to 10 GHz. The combined antenna and radome arrangement further comprises a radome. The radome has a first layer sandwiched between two second layers. The two second layers are of a second dielectric material. The first layer is of a first dielectric material and has a thickness t₁, where t₁≤λₘᵢₙ/3, wherein λₘᵢₙ is the wavelength of the highest frequency in the frequency range of the AAS. The radome is placed in front of the AAS such that the radome forms a cover for the AAS.

### TECHNICAL FIELD

Embodiments presented herein relate to a combined antenna and radome arrangement.

### BACKGROUND

In general terms, previously unused frequency bands either have been released or are to be released in the frequency range 3-10 GHz for fifth generation (5G) mobile communication systems. The legacy frequency bands used for second generation (2G) to fourth generations (4G) mobile communication systems are today predominately in the frequency range 0.6-2.7 GHz. Hence, new antenna systems need to be developed including the new frequency bands and by that also suitable antenna radomes.

In general terms, the radome has basically the function to give environmental protection to the antenna equipment while at the same time being transparent for electromagnetic radiation. The latter means that the radome should have transparency and reflectivity with respect to radio frequency (RF) propagation waves that gives a minimal impact on the radiation performance of the antenna equipment protected by the radome. Since the radome to a large extent sets the visual impression of the antenna system product comprising the antenna equipment, the radome is commonly developed as part of an industrial design process.

For 5G mobile communication systems, advanced antenna system (AAS), sometimes also referred to as an active antenna system, is one component to improve capacity and coverage, with respect to 2G-4G mobile communication systems, by making use of the spatial domain. In this respect, dynamic beamforming as enabled by AAS might impose harder requirements on the transparency and reflectivity of the radome with respect to RF propagation waves. One reason for this is that for typical legacy (i.e., non-AAS) antenna systems adapted for transmission and reception in a few fixed beams there is a possibility to, to some extent, compensate for the RF shortcomings of the radome by a thorough joint design of the antenna system and the radome. This possibility is much more limited for AAS since AAS should be able to operate using a much larger quantity of different beams for transmission and reception.

There are basically three types of radomes used for environmental protection; radomes that are electrically thin in terms of the wavelength (such as having a thickness of a fraction of the wavelength) at which the antenna system is intended to operate at; tuned solid radomes with an electrical thickness of half the wavelength (or a multiple thereof); and tuned sandwich radomes with an electrical thickness of a quarter of the wavelength (or an odd multiple thereof).

The radomes currently used for mobile communication antennas are solid radomes consisting of, for example, polycarbonate or polyester/glass fiber with a permittivity εᵣ, or dielectric constant in the range of 3≤εᵣ≤4.5. The thickness is commonly in the order of 2 mm to 4 mm. This means that electrically thin radomes are used, i.e. having an electrical thickness in the order of 0.05 wavelengths or less.

FIG. 1 shows the predicted transmission and reflections properties for a typical solid radome with a thickness of 3 mm as a function of frequency and illumination angle. At (a) and (b) are shown the results for an incident field with a polarization perpendicular to the plane of incidence while at (c) and (d) are shown the results for a polarization parallel to the plane of incidence. At (a) and (c) are shown the reflection properties and at (b) and (d) are shown the transmission properties of the radome.

A radome that in practice can be assumed to have negligible impact on an antenna system for mobile communication should have transmission losses predominately in the order of 0.2 dB to 0.3 dB or less and a reflectivity of predominately in the order of −15 dB to −20 dB or less. Higher amounts of reflected power will partly result in a mismatch of the antenna system and this reflected power will be re-scattered from the antenna system and by that interfere with the desired radiation performance.

It is clear from FIG. 1 that for frequency above 3 GHz this typical radome cannot be assumed to have negligible impact on the radiation performance. A possibility is to make the radome thinner, but a radome thinner than 2 mm will have difficulties in terms of handling mechanical requirements as well as being challenging to manufacture. There is also a possibility to some extent compensate RF shortcomings of the radome by a thorough joint design of the antenna system and the radome together. However, such a joint design might be challenging to achieve and might still not result in the RF shortcomings being fully compensated for.

In view of the above, there is still a need for improved radomes for AASs.

### SUMMARY

An object of embodiments herein is to provide a radome suitable for AASs where the radome does not suffer from the above issues, or at least where the above issues have been mitigated or reduced.

According to a first aspect there is presented a combined antenna and radome arrangement. The combined antenna and radome arrangement comprises an advanced antenna system (AAS). The AAS comprises antenna elements and is configured for communication in a frequency range of 2.5 GHz to 10 GHz. The combined antenna and radome arrangement further comprises a radome. The radome has a first layer sandwiched between two second layers. The two second layers are of a second dielectric material. The first layer is of a first dielectric material and has a thickness t₁, where t₁≤λₘᵢₙ/3, wherein λₘᵢₙ is the wavelength of the highest frequency in the frequency range of the AAS. The radome is placed in front of the AAS such that the radome forms a cover for the AAS.

Advantageously this radome does not suffer from the above issues.

Advantageously this radome has a negligible impact on the RF-radiation performance of the AAS, i.e. the radiation performance can in practice be assumed to be the same as without the radome.

According to a second aspect there is presented a combined antenna and radome arrangement according to the first aspect that further comprises a non-advanced antenna system (non-AAS). The non-AAS comprises antenna elements and is configured for communication in a frequency range of 0.6-2.7 GHz. The radome is placed in front of the non-AAS such that the radome forms a common cover for the AAS and the non-AAS.

Advantageously this allows both the AAS and the non-AAS to be covered by one and the same radome and hence could alleviate the need for separate radomes for the 3o AAS and the non-AAS.

Advantageously this radome has a negligible impact on the RF-radiation performance of the AAS as well as the non-AAS, i.e. the radiation performance can in practice be assumed to be the same as without the radome.

Advantageously this radome can be used with an off-the-shelf passive antenna system together with an AAS.

Advantageously the combined antenna and radome arrangement is modular and flexible in terms of a variety of combinations of off-the-shelf passive antenna system and off-the-shelf AAS.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates predicted transmission and reflections properties for a radome according to state of the art;

FIG. 2 schematically illustrates a combined antenna and radome arrangement according to an embodiment;

FIG. 3 schematically illustrates a radome according to an embodiment;

FIG. 4 schematically illustrates an AAS and a non-AAS, and a combined antenna and radome arrangement for the AAS and the non-AAS according to an embodiment; and

FIGS. 5, 6, 7, and 8 schematically illustrate predicted transmission and reflections properties for a radome according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As disclosed above there is a need for improved radomes for AASs. Some of the embodiments disclosed herein therefore relate to a radome concept for mobile communication sites having antenna system configured to operate in the frequency range of 3 GHz to 10 GHz.

To accomplish this, there is a stringent requirement on that the radome having negligible impact on the performance of the antenna system covered by the radome. If this is not the case, the antenna systems cannot be assumed to have the same performance as without the radome. This can to some extent be handled by re-verifying and re-defining product performance with the radome in place. However, this would impact the flexibility and modularity of the combined antenna and radome arrangement.

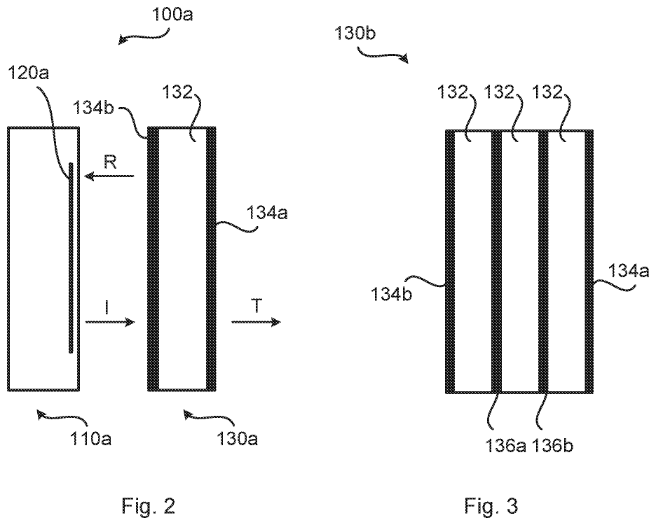

Reference is now made to FIG. 2 that schematically illustrates a combined antenna and radome arrangement 100a according to an embodiment, not drawn to scale. In FIG. 2, “R” is short for reflectance, “T” is short for transmission, and “I” is short for incident field and denotes radiated emission/reception of radio waves.

The combined antenna and radome arrangement 100a comprises an advanced antenna system (AAS) 110a. In turn, the AAS 110a comprises antenna elements 120a. The AAS 110a is configured for communication in a frequency range of 2.5 GHz to 10 GHz. In some examples the AAS 110a only is to operate in a subrange of this frequency range.

The combined antenna and radome arrangement 100a further comprises a radome 130a. The radome 130a is placed in front of the AAS 110a such that the radome 130a forms a cover for the AAS 110a.

In some aspects the radome 130a is of a broadband untuned sandwich design, comprising two outer skins (hereinafter denoted second layers) having a core (hereinafter denoted first layer) there in between. In particular, the radome 130a has a first layer 132 and two second layers 134a, 134b.

The first layer 132 has a thickness t₁, where t₁≤λₘᵢₙ/3, wherein λₘᵢₙ is the wavelength of the highest frequency in the frequency range of the AAS 110a. When the AAS 110a only is to operate in a subrange of the frequency range, the highest frequency might be the highest frequency of the subrange.

The first layer 132 is of a first dielectric material. The first layer 132 is sandwiched between the two second layers 134a, 134b. The two second layers 134a, 134b are of a second dielectric material. According to this sandwich design, the radome 130a thus comprises at least three layers.

Further aspects, embodiments, and examples of the radome 130a will be disclosed below.

The radome 130a according to the above has a negligible impact on the RF-radiation performance of the AAS 110a. That is, the radiation performance of the AAS 110a can in practice be assumed to be the same as without the radome 130a.

Using a sandwich design for the radome 130a gives the combined benefit of attractive RF performance and mechanical strength.

Embodiments relating to further details of the combined antenna and radome arrangement 100a, 100b will now be disclosed.

In some aspects the radome 130a is placed in front of the AAS 110a such that one of the second layers 134a, 134b faces the antenna elements 120a of the AAS 110a. In the illustrative example of FIG. 2 the second layer 134b faces the antenna elements 120a of the AAS 110a.

Aspects of the first layer 132 will now be disclosed.

As disclosed above, the first layer 132 has a thickness t₁, where t₁≤λₘᵢₙ/3. In some aspects the first layer 132 is even thinner. For example, according to an embodiment, t₁≤λₘᵢₙ/4. Further in this respect there might be a minimum thickness of the first layer 132. For example, according to an embodiment, t₁>1.5 mm.

As disclosed above, the first layer 132 is of a first dielectric material. There might be different kinds of such first dielectric materials. In some aspects the first dielectric material is defined by its permittivity ε_{r,1}. In some aspects the first layer 132 is of a material having low permittivity to achieve attractive electrical characteristics (such as low reflectivity and loss) for the radome 130a. In this respect the first dielectric material might have a permittivity ε_{r,1}, where 1≤ε_{r,1}≤1.5. Preferably, 1.05≤ε_{r,1}≤1.2.

As an example, the first dielectric material could be a solid foam with closed or open cells, such as a PolyMethacrylImide (PMI) foam.

Additionally, or alternatively to using a PMI foam, there might be a support structure sandwiched between the second layer 134a, 134b. Particularly, according to an embodiment, the radome 130a further comprises a support structure disposed in the in the first layer 132. Using a support structure could result in a glass fiber reinforced polymer sandwich construction for the radome 130a. There could be different types of support structures. According to some examples the support structure has the geometry of a honeycomb. The radome 130a might thus have a honeycomb core defining the first layer 132.

Aspects of the second layers 134a, 134b will now be disclosed.

In general terms, each second layer 134a, 134b has a thickness t_{2,1}, t_{2,2}. That is, the second layer 134a has a thickness t_{2,1} and the second layer 134b has a thickness t_{2,2}. According to an embodiment each second layer 134a, 134b has a thickness t_{2,1}, t_{2,2} in the range 0.1 mm to 0.5 mm. That is, according to an embodiment, 0.1 mm t_{2,1}, t_{2,2}≤0.5 mm.

In some aspects both second layers 134a, 134b are of the same thickness, that is t_{2,1}=t_{2,2}. However, in other aspects the second layers 134a, 134b are not of the same thickness, that is t_{2,1}≠t_{2,2}. In this respect the second layer 134a facing away from the antenna elements 120a might be thicker than the second layer 134b facing the antenna elements 120a. This might enable improved protection from the physical environment surrounding the AAS 110a. That is, according to an embodiment, the second layer 134b facing the antenna elements 120a might be thinner than the other second layer 134a.

As disclosed above, the second layers 134a, 134b are of a second dielectric material. There might be different kinds of such second dielectric materials. In some aspects the second dielectric material is defined by its permittivity ε_{r,2}. In this respect the second dielectric material might have a permittivity ε_{r,2}, where 2.5≤ε_{r,2}≤5. Preferably, 4≤ε_{r,1}≤4.7.

Further, each of the second layers 134a, 134b could comprise several thin layers resulting in a total thickness t_{2,1}, t_{2,2}, and resulting permittivity ε_{r,2}. These thin layers could be of, or comprise, glass fiber fabric, high-modulus polyethylene (HMPE), adhesive layers, ultraviolet (UV) protection film, polyester, epoxy, surface coating, etc.

In some aspects the radome comprises at least one further layer. Reference is here made to FIG. 3 that schematically illustrates a radome 130b according to an embodiment. The radome 130b could replace the radome 130a in FIG. 2 and thus be combined with the AAS 110a in the combined antenna and radome arrangement 100a.

As for the radome 130a, the radome 130b has a first layer 132 with properties as disclosed above in terms of thickness and dielectric material. The first layer 132 is sandwiched between two second layers 134a, 134b with properties as disclosed above in terms of thickness and dielectric material. As above, a support structure might be disposed in the first layer 132.

The radome 130b of FIG. 3 further comprises at least one further layer 136a, 136b. Each of the at least one further layer 136a, 136b is disposed in the first layer 132. Each of the at least one further layer 136a, 136b is distanced from the second layers 134a, 134b. Each of the at least one further layer 136a, 136b is arranged in parallel with the second layers 134a, 134b.

In the illustrative example of FIG. 3, the radome 130b comprises two such further layers 136a, 136b. However, the radome 130b might be designed to, in principle, have any number of layers. In the illustrative example of FIG. 3, the distances between the second layers 134a, 134b and the further layers 136a, 136b are all the same. However, the further layers 136a, 136b need to be placed equidistant with respect to the second layers 134a, 134b.

Providing the radome 130b with further layers 136a, 136b might increase the mechanical strength of the radome 130b.

Aspects of the further layers 136a, 136b will now be disclosed.

In general terms, each further layer 136a, 136b has a thickness. In some aspects all further layers 136a, 136b are of the same thickness. Particularly, according to an embodiment, each of the at least one further layer 136a, 136b has a thickness in the range 0.1 mm to 0.5 mm. That is, each further layer 136a, 136b might have a thickness equal to the thickness of at least one of the second layers 134a, 134b. Having all second layers 134a, 134b and all further layers 136a, 136b of the same thickness simplifies production of these layers.

In general terms, each further layer 136a, 136b is of a dielectric material. There might be different kinds of such dielectric materials. In some aspects the dielectric material is defined by its permittivity. In some aspects each further layer 136a, 136b is of a dielectric material with the same permittivity as the second dielectric material. In particular, according to an embodiment, each of the at least one further layer 136a, 136b is of the second dielectric material.

Having all second layers 134a, 134b and all further layers 136a, 136b of the same dielectric material simplifies production of these layers.

In the roll-out of new frequency bands on existing mobile communication sites with legacy AAS (such as non-AAS) it is in many cases not possible to just add new equipment to the existing legacy antenna hardware. In fact, many existing mobile communication sites have restrictions on the number of hardware units allowed to be placed on the site. These restrictions might be driven by requirements that the mobile communication sites, and especially the antenna systems at the site, should be visually appealing. One way to accomplish this is to have a modular arrangement which is flexible to house antenna systems of different types, such as an AAS 110a and a non-AAS.

According to some aspects there is therefore provided a modular arrangement where an AAS (or other antenna system configured to operate in the frequency range 2.5 GHz to 10 GHz) is combined with a non-AAS (or other legacy antenna system configured to operate in the frequency range 0.6 GHz to 2.7 GHz) and covered by a common radome.

Hence, according to an embodiment the combined antenna and radome arrangement further comprises a non-AAS 110b. In this respect, the non-AAS 110b is a passive (legacy) antenna system. The non-AAS 110b comprises antenna elements 120b. The non-AAS 110b is configured for communication in a frequency range of 0.6-2.7 GHz.

The radome 130a, 130b is placed in front of the non-AAS 110b (and the AAS 110a) such that the radome 130a, 130b forms a common cover for the AAS 110a and the non-AAS 110b.

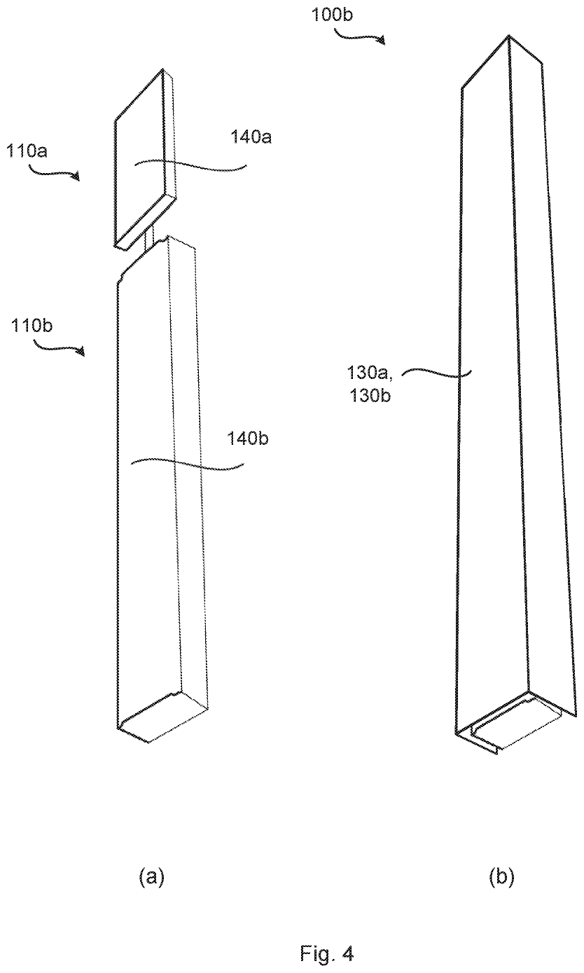

FIG. 4(a) schematically illustrates an AAS 110a and a non-AAS 110b. FIG. 4(b) schematically illustrates a combined antenna and radome arrangement 100b for the AAS and the non-AAS according to an embodiment. In FIG. 4(b) the radome 130a, 130b is placed in front of the AAS 110a and the non-AAS 110b of FIG. 4(a) such that the radome 130a, 130b forms a common cover for the AAS 110a and the non-AAS 110b.

In the illustrative example of FIG. 4(a) the non-AAS 110b has its own inner radome 140b. This could be the case where the non-AAS 110b is provided as an off-the-shelf product. The inner radome 140b is placed in front of the antenna elements 120b of the non-AAS 110b. As in FIG. 4(b) the radome 130a, 130b then forms an outer radome for the non-AAS 110b.

Further, in the illustrative example of FIG. 4(a) also the AAS 110a has its own inner radome 140a. This could be the case where the AAS 110a is provided as an off-the-shelf product. The inner radome 140a is placed in front of the antenna elements 120a of the AAS 110a. As in FIG. 4(b) the radome 130a, 130b then forms an outer radome for the AAS 110a.

In the example of FIG. 4(b) the outer radome 130a, 130b is common for both the AAS 110a and the non-AAS 110b. It could be that the radome 130a, 130b takes the place of, and thus replaces, the inner radome 140a of the AAS 110a. This could be the case where the AAS 110a is not provided as an off-the-shelf product and represents the example illustrated in FIG. 2. In such a case the thus single radome of the AAS 110a might be extended to also cover the non-AAS 110b (which may or may not have its own inner radome 140b). Alternatively, the radome of the AAS 110a is not extended. A further radome is then provided on top of the radome of the AAS 110a to cover the AAS as well as the non-AAS 110b, as in FIG. 4(b).

There could be different ways to place the AAS 110a and the non-AAS 110b with respect to each other.

In some aspects the AAS 110a and the non-AAS 110b are placed to have the same general direction for transmission and reception. Particularly, according to an embodiment, the AAS 110a and the non-AAS 110b are placed such that the antenna elements 120a of the AAS 110a and the antenna elements 120b of the non-AAS 110b face the same direction. In this respect the face of the AAS 110a and the face of the non-AAS 110b where the antenna elements 120a, 120b are placed might thus face the same direction.

In some aspects the radome 130a, 130b is placed in front of the non-AAS 110b such that one of the second layers 134a, 134b faces the antenna elements 120a of the AAS 110a and the antenna elements 120b of the non-AAS 110b.

In the illustrative example of FIG. 4, the AAS 110a is placed on top of the non-AAS 110b. In other examples the non-AAS 110b might be placed on top of the AAS 110a. In yet other examples the AAS 110a and the non-AAS 110b are placed next to each other. In all these cases radome 130a, 130b is placed in front of the non-AAS 110b (and the AAS 110b) such that the radome 130a, 130b forms a common cover for the AAS 110a and the non-AAS 110b

In general terms, the radome 130a, 130b can be of any shape that enables the radome 130a, 130b to form a common cover for the AAS 110a and the non-AAS 110b and thus enables concealment of antenna systems at mobile communication sites. The following are examples of mobile communication site installations were the herein disclosed the radome 130a, 130b can be used to conceal antenna systems. The mobile communication site can be placed on top of buildings or on walls. The mobile communication site can be placed on top of information signs. The mobile communication site can be placed on top of electrical car charging stations. The mobile communication site can be placed on top of shelters at public transportation stops (such as bus stops or tram stops). The mobile communication site can be placed in a street environment.

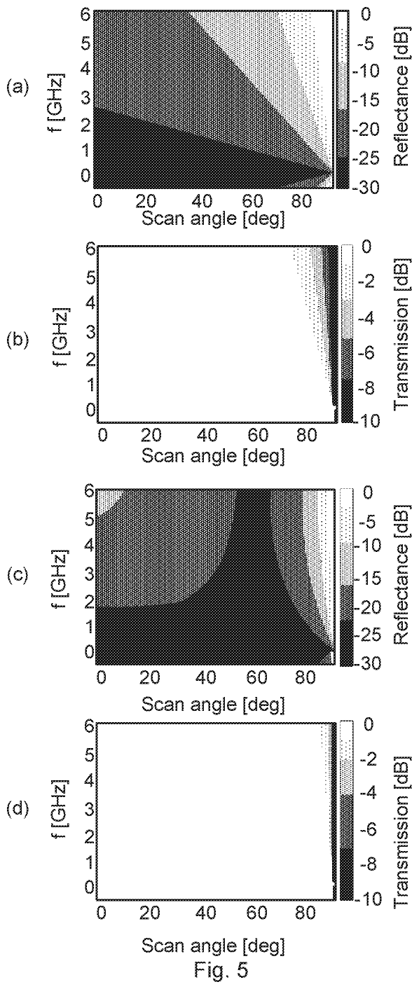

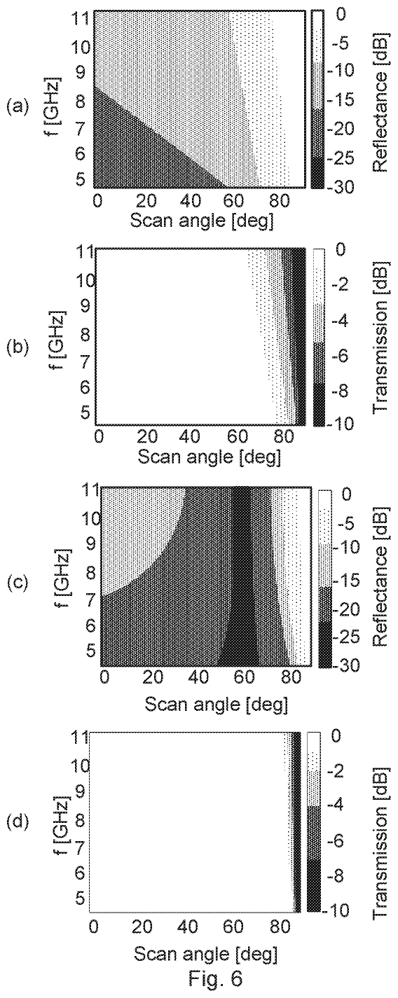

FIG. 5 and FIG. 6 show the predicted transmission and reflections properties for an example of the herein disclosed radome 130a as a function of frequency and illumination angle. At (a) and (b) are shown the results for an incident field with a polarization perpendicular to the plane of incidence while at (c) and (d) are shown the results for a polarization parallel to the plane of incidence. At (a) and (c) are shown the reflection properties and at (b) and (d) are shown the transmission properties of the radome.

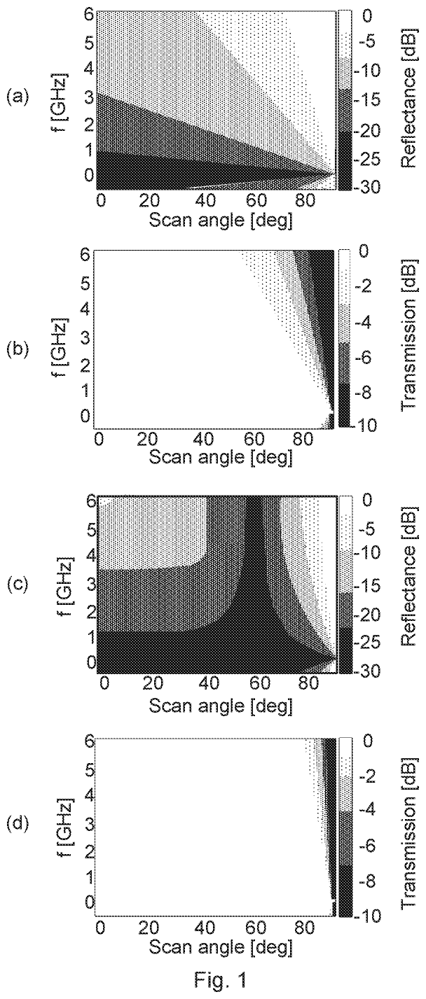

The radome 130a used for the results in FIG. 5 and FIG. 6 is electrically thin and consists of two second layers 134a, 134b each having a thickness t_{2,1}, t_{2,2} of 0.3 mm and being of a second dielectric material with a permittivity ε_{r,2}=4.4, and a first layer 132 of a thickness t₁ of 2.5 mm and being of a first dielectric material with a permittivity ε_{r,1}=1.11. Comparing the results to FIG. 1, it is seen that the proposed radome 130a has significantly better RF performance than the legacy radome. Further, as can be seen in FIG. 5 and FIG. 6 the proposed radome 130a can be assumed to have a negligible impact on an AAS configured to operate up to frequencies well above 4.5 GHz.

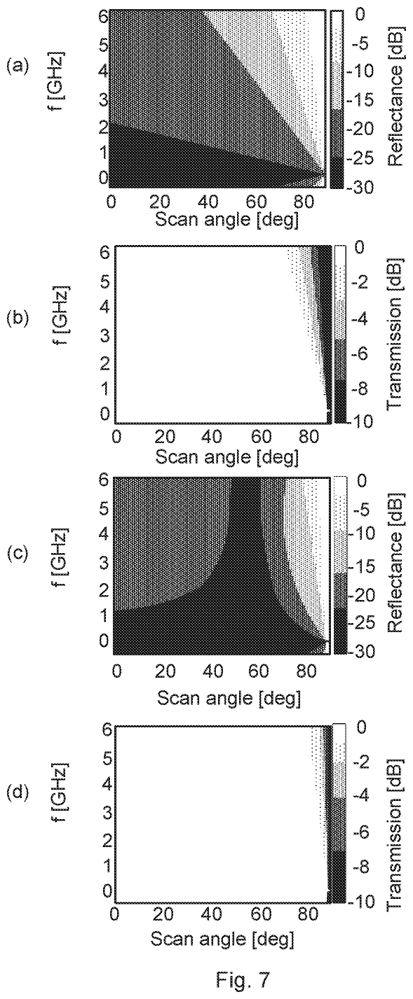

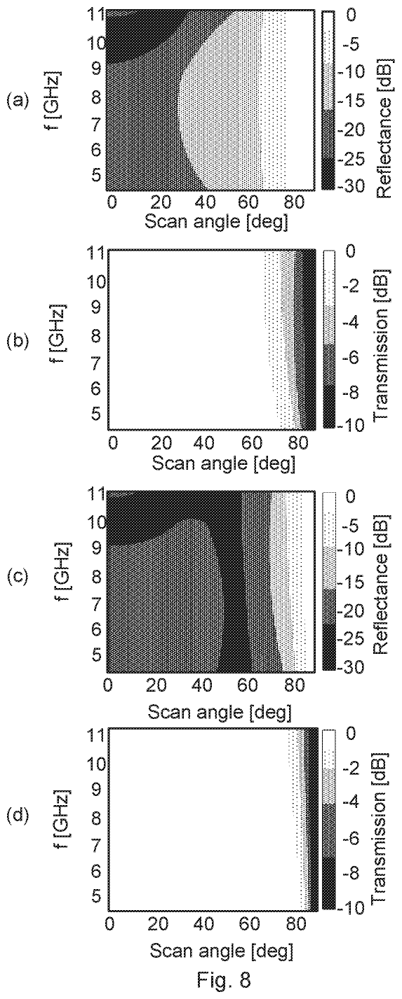

The performance in the frequency range 5 GHz to 10 GHz can be further improved by increasing the thickness of the first layer 132. FIG. 7 and FIG. 8 show the predicted transmission and reflections properties for another example of the herein disclosed radome 130a where the thickness t₁ of the first layer 132 is increased to 7.5 mm. In other respects the radome 130a as used for the results in FIG. 7 and FIG. 8 is identical to the one used for the results in FIG. 5 and FIG. 6. At (a) and (b) are shown the results for an incident field with a polarization perpendicular to the plane of incidence while at (c) and (d) are shown the results for a polarization parallel to the plane of incidence. At (a) and (c) are shown the reflection properties and at (b) and (d) are shown the transmission properties of the radome. Increasing the thickness t₁ of the first layer 132 to 7.5 mm implies that the thickness of the first layer 132 is in the order of quarter wavelengths at 10 GHz, whilst being electrically thin and untuned at the lower frequencies. Further, as can be seen in FIG. 7 and FIG. 8 the proposed radome 130a can be assumed to have a negligible impact on an AAS configured to operate up to frequencies up to 10 GHz.

Although the combined antenna and radome arrangements 110a, 100b have been described as comprising one AAS 110a (and, optionally, one non-AAS 110b), the combined antenna and radome arrangements 110a, 100b might generally comprise at least one AAS 110a (and, optionally, at least one non-AAS 110b) where the radome 130a, 130b is placed in front of each of the at least one AAS 110a (and, optionally, in front of each of the at least one non-AAS 110b) such that the radome 130a, 130b forms a cover for each of the at least one AAS 110a (and, optionally, for each one of the at least one non-AAS 110b). Hence, the radome 130a, 130b might form a common cover for at least two AASs of the same or different type, optionally combined with at least two non-AASs of the same or different type.

The AAS 110a and/or the non-AAS 110b might be part of a radio access network node, radio base station, base transceiver station, node B (NB), evolved node B (eNB), gNB, or access point.

The herein disclosed radome 130a, 130b can be cost efficiently manufactured using pultrusion production techniques.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A combined antenna and radome apparatus, comprising:
an advanced antenna system, AAS, the AAS comprising antenna elements and being configured for communication in a frequency range of 2.5 GHz to 10 GHz; and
a radome, the radome having a first layer sandwiched between two second layers, the two second layers being of a second dielectric material, and the first layer being of a first dielectric material and having a thickness t1, where t1≤λ min/3, wherein λ min is the wavelength of the highest frequency in the frequency range of the AAS, wherein
the radome is placed in front of the AAS such that the radome forms a cover for the AAS.

2. The apparatus according to claim 1, wherein the radome is placed in front of the AAS such that one of the second layers faces the antenna elements of the AAS.

3. The apparatus according to claim 1, wherein t1>1.5 mm.

4. The apparatus according to claim 1, wherein t1≤λ min/4.

5. The apparatus according to claim 1, wherein the first dielectric material has a permittivity ε r,1, where 1≤ε r,1≤1.5, preferably 1.05≤εr,1≤1.2.

6. The apparatus according to claim 1, wherein the second dielectric material has a permittivity ε r,2, where 2.5≤ε r,2≤5, preferably 4≤ε r,1≤4.7.

7. The apparatus according to claim 1, wherein each second layer has a thickness t2,1, t2,2 in the range 0.1 mm to 0.5 mm.

8. The apparatus according to claim 2, wherein the second layer facing the antenna elements is thinner than the other second layer.

9. The apparatus according to claim 1, wherein the radome further comprises:
at last one further layer, the at least one further layer being disposed in the first layer, distanced from the second layers, and arranged in parallel with the second layers.

10. The apparatus according to claim 9, wherein each of the at least one further layer has a thickness in the range 0.1 mm to 0.5 mm.

11. The apparatus according to claim 9, wherein each of the at least one further layer is of the second dielectric material.

12. The apparatus according to claim 1, wherein the radome further comprises:
a support structure disposed in the in the first layer.

13. The apparatus according to claim 12, wherein the support structure has the geometry of a honeycomb.

14. The apparatus according to claim 1, wherein the first dielectric material is a solid foam with closed or open cells, such as a Polymethacrylimide, PMI, foam.

15. The apparatus according to claim 1, further comprising:
a non-advanced antenna system, non-AAS, the non-AAS comprising antenna elements and being configured for communication in a frequency range of 0.6-2.7 GHz, and
wherein the radome is placed in front of the non-AAS such that the radome forms a common cover for the AAS and the non-AAS.

16. The apparatus according to claim 15, wherein the AAS and the non-AAS are placed such that the antenna elements of the AAS and the antenna elements of the non-AAS face the same direction.

17. The apparatus according to claim 15, wherein the radome is placed in front of the non-AAS such that one of the second layers faces the antenna elements of the AAS and the antenna elements of the non-AAS.

18. The apparatus according to claim 15, wherein the radome is an outer radome, wherein the non-AAS further comprises an inner radome placed in front of the antenna elements of the non-AAS.

19. The apparatus according to claim 15, wherein the radome is an outer radome, wherein the AAS further comprises an inner radome placed in front of the antenna elements of the AAS.
